(19) United States
(12) Patent Application Publication
(10) Pub. No.: US 2011/0074604 A1
(43) Pub. Date: Mar. 31, 2011

(54) AUTOMATIC PARALLEL PARKING DEVICE

(75) Inventors: Tsung Hua HSU, Changhua County (TW); Chan Wei HSU, Changhua County (TW); Chia Feng LIN, Changhua County (TW); Chi Chun YAO, Changhua County (TW)

(73) Assignee: AUTOMOTIVE RESEARCH & TESTING CENTER, Changhua County (TW)

(21) Appl. No.: 12/647,133

(22) Filed: Dec. 24, 2009

(30) Foreign Application Priority Data
Sep. 29, 2009 (TW) 098132922

(51) Int. Cl. G08G 1/14

(52) U.S. Cl. 340/932.2

(57) ABSTRACT

An automatic parallel parking device includes an ultrasonic positioning module and a central controlling unit. The ultrasonic positioning module includes a plurality of ultrasonic sensor units disposed at different locations of the vehicle, and a computation unit. Each of the ultrasonic sensor units detects a distance to each of the first obstacle and the second obstacle. The computation unit has a pre-established space positioning matrix and pre-established approximate coordinate data, and estimates a first actual coordinate position of the first obstacle and a second actual coordinate position of the second obstacle based on the distances detected by the ultrasonic sensor units. The central controlling unit is coupled to the ultrasonic positioning module. The central controlling unit has a pre-established parking path algorithm and a pre-established minimal parking space.

### BACKGROUND OF THE INVENTION

1. Field of the Invention

The present invention relates to a parking device, more particularly to an automatic parallel parking device.

2. Description of the Related Art

A conventional automatic parallel parking system uses many ultrasonic detectors to detect respective distances to each of a first obstacle and a second obstacle, and roughly estimates positions of the first and second obstacles based on the distances detected by the ultrasonic detectors. Although the ultrasonic detectors can detect whether obstacles are present in a specific range, they cannot detect accurate positions of the obstacles such that the automatic parking system is unable to make accurate determinations before a vehicle is parked automatically.

Furthermore, the conventional automatic parking system uses a pre-established algorithm to generate an automatic parking path. Generally, two steering positions for parking a vehicle are planned when the conventional automatic parking system uses this algorithm to generate the parking path. Consequently, a large parking space is needed. When the parking space is small, the system will determine that parking is not possible, that is, not possible with use of only the planned two steering positions.

### SUMMARY OF THE INVENTION

Therefore, the object of the present invention is to provide an automatic parallel parking device, which is able to facilitate automatic parallel parking in a small parking space.

Accordingly, an automatic parallel parking device of the present invention comprises an ultrasonic positioning module and a central controlling unit.

The ultrasonic positioning module includes a plurality of ultrasonic sensor units disposed at different locations of the vehicle, and a computation unit. Each of the ultrasonic sensor units detects a distance to each of the first obstacle and the second obstacle. The computation unit has a pre-established space positioning matrix and pre-established approximate coordinate data, and estimates a first actual coordinate position of the first obstacle and a second actual coordinate position of the second obstacle based on the distances detected by the ultrasonic sensor units. Based on the space positioning matrix and the approximate coordinate data, the computation unit further estimates parking space dimension data of the parking space based on at least the first and second actual coordinate positions of the first and second obstacles.

The central controlling unit is coupled to the ultrasonic positioning module. The central controlling unit has a pre-established parking path algorithm and a pre-established minimal parking space. The central controlling unit is associated with various controls of the vehicle, and receives the first and second actual coordinate positions of the first and second obstacles and the parking space dimension data from the computation unit of the ultrasonic positioning module.

When the parking space is not smaller than the minimal parking space, the central controlling unit generates a parking path including at least two different steering wheel positions on the basis of the first and second actual coordinates of the first and second obstacles, the parking space dimension data, and the parking path algorithm, subsequently controls the vehicle to park in the parking space along the parking path, and finally utilizes a horizontal displacement of the vehicle to determine whether the vehicle is parked in the parking space.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of an automatic parallel parking device according to a preferred embodiment of the present invention;

FIG. 2 is a schematic circuit block diagram of the preferred embodiment to illustrate a structure of an ultrasonic positioning module;

FIG. 3 is a schematic circuit block diagram of the preferred embodiment to illustrate a structure of a computation unit;

FIG. 4 is a schematic circuit block diagram of the preferred embodiment to illustrate a structure of a central controlling unit;

FIG. 5 is a schematic circuit block diagram of the preferred embodiment to illustrate a structure of a vehicle body sensor unit; and

FIG. 6 is a schematic diagram, illustrating a path along which a vehicle is automatically parked and various dimensions used during automatic parking according to the preferred embodiment.

### DETAILED DESCRIPTION OF THE PREFERRED EMBODIMENT

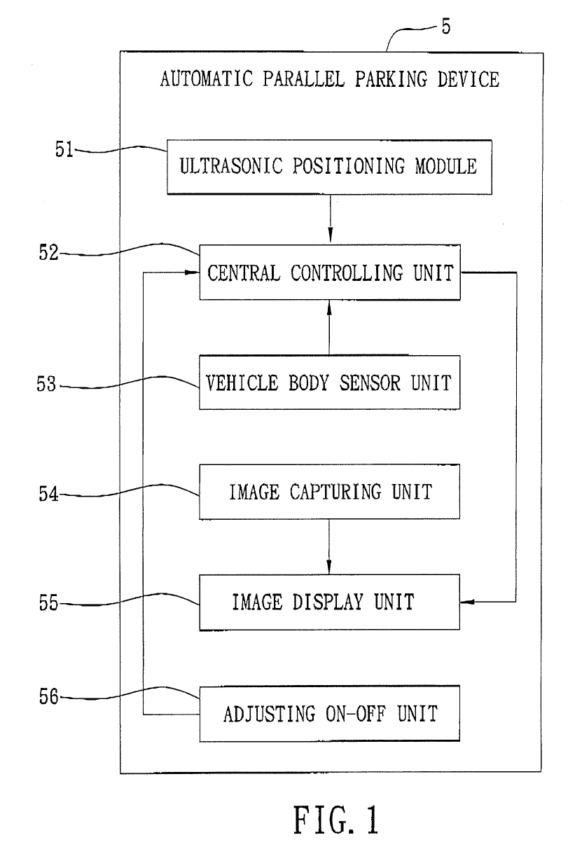

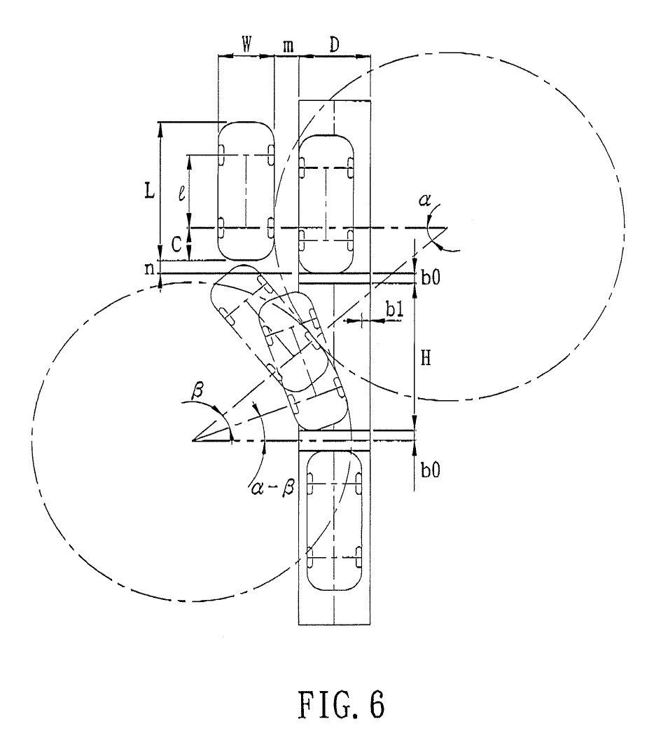

Referring to FIG. 1, a preferred embodiment of an automatic parallel parking device 5 of the present invention is used for automatically parking a vehicle in a parking space next to a curb, and between a first obstacle and a second obstacle. For purposes of illustration, with reference to FIG. 6, the first and second obstacles are assumed to be other vehicles parked along the curb, and the second vehicle is substantially in line with the first vehicle.

The automatic parallel parking device 5 comprises an ultrasonic positioning module 51, a central controlling unit 52, a vehicle body sensor unit 53, an image capturing unit 54, an image display unit 55, and an adjusting on-off unit 56.

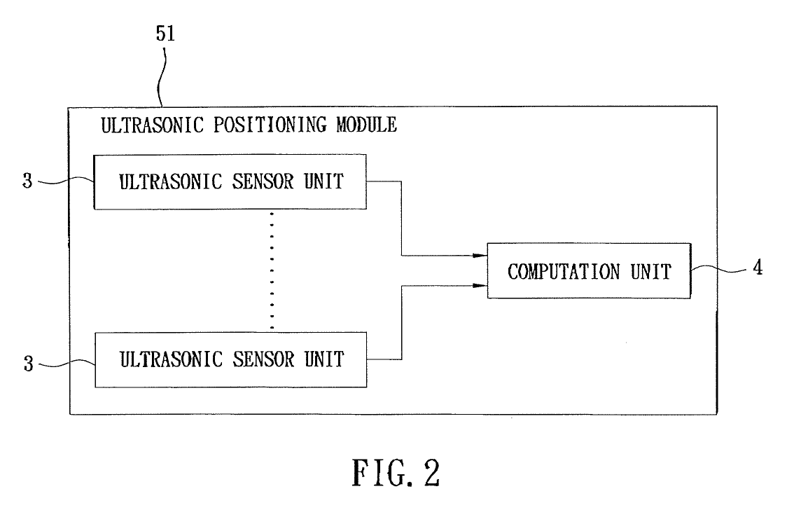

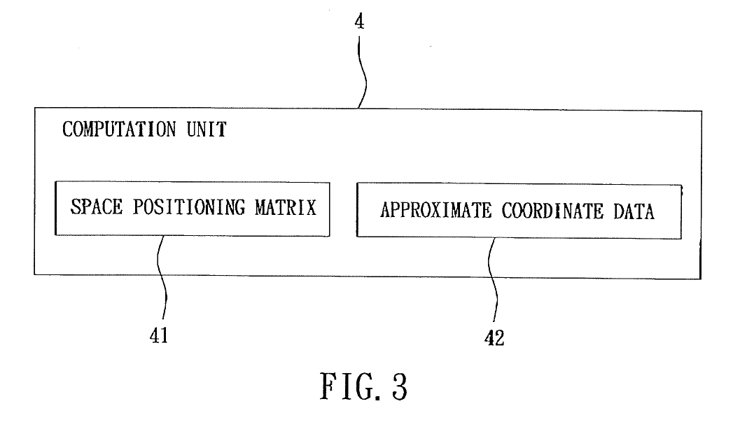

Referring to FIGS. 2 and 3, the ultrasonic positioning module 51 includes a plurality of ultrasonic sensor units 3 disposed at different locations of the vehicle, and a computation unit 4. Each of the ultrasonic sensor units 3 detects a distance to each of the first obstacle and the second obstacle. The computation unit 4 has a pre-established space positioning matrix 41 and pre-established approximate coordinate data 42, and estimates a first actual coordinate position of the first obstacle and a second actual coordinate position of the second obstacle based on the distances detected by the ultrasonic sensor units 3, and further based on the space positioning matrix 41 and the approximate coordinate data 42. The computation unit 4 further estimates parking space dimension data of the parking space based on at least the first and second actual coordinate positions of the first and second obstacles.

The space positioning matrix 41 is represented by

$$[ \begin{matrix}\frac{( \hat{x} - {x}_{1} )}{{\hat{ρ}}_{1}} & \frac{( \hat{y} - {y}_{1} )}{{\hat{ρ}}_{1}} & \frac{( \hat{z} - {z}_{1} )}{{\hat{ρ}}_{1}} \\ \frac{( \hat{x} - {x}_{2} )}{{\hat{ρ}}_{2}} & \frac{( \hat{y} - {y}_{2} )}{{\hat{ρ}}_{2}} & \frac{( \hat{z} - {z}_{2} )}{{\hat{ρ}}_{2}} \\ ⋮ & ⋮ & ⋮ \\ \frac{( \hat{x} - {x}_{n} )}{{\hat{ρ}}_{n}} & \frac{( \hat{y} - {y}_{n} )}{{\hat{ρ}}_{n}} & \frac{( \hat{z} - {z}_{n} )}{{\hat{ρ}}_{n}}\end{matrix} ] \qquad ( 1 )$$

where (\hat{x}, ŷ, \hat{z}) is an estimated coordinate position of one of the first obstacle and the second obstacle, (x₁, y₁, z₁), (x₂, y₂, z₂), . . . , and (xₙ, yₙ, zₙ) are coordinate positions respectively of the ultrasonic sensor units 3, and \hat{ρ}₁, \hat{ρ}₂, . . . , and \hat{ρ}ₙ are the distances detected respectively by the ultrasonic sensor units 3 and said one of the first obstacle and the second obstacle.

The actual coordinate position of each of the first obstacle and the second obstacle is calculated by

$$\begin{matrix}[ \begin{matrix}{ρ}_{1} - {\hat{ρ}}_{1} \\ {ρ}_{2} - {\hat{ρ}}_{2} \\ ⋮ \\ {ρ}_{n} - {\hat{ρ}}_{n}\end{matrix} ] = [ \begin{matrix}\frac{( \hat{x} - {x}_{1} )}{{\hat{ρ}}_{1}} & \frac{( \hat{y} - {y}_{1} )}{{\hat{ρ}}_{1}} & \frac{( \hat{z} - {z}_{1} )}{{\hat{ρ}}_{1}} \\ \frac{( \hat{x} - {x}_{2} )}{{\hat{ρ}}_{2}} & \frac{( \hat{y} - {y}_{2} )}{{\hat{ρ}}_{2}} & \frac{( \hat{z} - {z}_{2} )}{{\hat{ρ}}_{2}} \\ ⋮ & ⋮ & ⋮ \\ \frac{( \hat{x} - {x}_{n} )}{{\hat{ρ}}_{n}} & \frac{( \hat{y} - {y}_{n} )}{{\hat{ρ}}_{n}} & \frac{( \hat{z} - {z}_{n} )}{{\hat{ρ}}_{n}}\end{matrix} ] [ \begin{matrix}δ x \\ δ y \\ δ z\end{matrix} ] & ( 2 ) \\ δ p = {( {H}^{T} H )}^{- 1} {H}^{T} δρ & ( 3 ) \\ x = \hat{x} + δ x , y = \hat{y} + δ y , z = \hat{z} + δ z & ( 4 )\end{matrix}$$

where δx, δy, and δz are errors between the estimated coordinate position and the actual coordinate position of said one of the first obstacle and the second obstacle in the x, y, and, z directions, respectively, ρ₁, ρ₂, . . . , and ρₙ are the distances detected respectively by the ultrasonic sensor units 3, δρ is a matrix formed by a difference between (a) distances between the ultrasonic sensor units 3 and said one of the first and second actual coordinate position and (b) distances between the ultrasonic sensor units 3 and the estimated coordinate position of said one of the first obstacle and the second obstacle, H is the space positioning matrix 41, δp is a matrix formed using δx, δy, and δz, and x, y, and z are components of the actual coordinate position.

The distances (ρ₁, ρ₂, . . . , ρₙ) detected by the ultrasonic sensor units 3 are transmitted to the computation unit 4. Subsequently, the distances (ρ₁, ρ₂, . . . , ρₙ), the estimated coordinate position (\hat{x}, ŷ, \hat{z}), and the respective coordinate positions of the ultrasonic sensor units 3, (x₁, y₁, z₁), (x₂, y₂, z₂), . . . , and (xₙ, yₙ, zₙ) are substituted into Equation (2), and then undergo an inverse matrix operation of Equation (3) so as to obtain errors, δx, δy and δz, between the estimated coordinate positions and the actual coordinate positions. The errors δx, δy, and δz are then substituted into Equation (4) to obtain the actual coordinate position (x, y, z). The actual coordinate position of said one of the first obstacle and the second obstacle is calculated by recursive substitution.

it is noted that the aforesaid Equations for calculating the actual coordinate position undergo a significant number of recursive computations, i.e., the actual coordinate position (x, y, z) for each of the first obstacle and the second obstacle undergoes a significant number of estimations, and the errors δx, δy, and δz become smaller and smaller in the recursive computations until the errors are smaller than a threshold, value. Accordingly, the actual coordinate position (x, y, z) for each of the first obstacle and the second obstacle can be estimated accurately.

In this embodiment, two measured values are taken for input fuzzy, i.e., a fuzzy table is utilized to obtain a K value, in order to reduce the recursive computations, before using the aforesaid conditions to estimate the actual coordinate position (x, y, z) for each of the first obstacle and the second obstacle. The K value is substituted into the following condition for defuzzification,

$${K}^{′} = \frac{\sum {y}_{i} {w}_{i} K}{\sum {y}_{l}} \qquad ( 5 )$$

Then, a weight calculation is adopted to obtain an initialized guessed position as follows:

(\hat{x},ŷ)=(1−K′)·(x₂=ρ₂·sin θ,y₂+ρ₂·cos θ)+K′·(x₁+ρ₁·sin θ,y₁+ρ₁·cos θ) (6)

where θ is a turning angle after the vehicle moves.

Then, the initialized guessed position is substituted into Equation (2) for recursive computations, such that the number of the recursive computations can be effectively reduced.

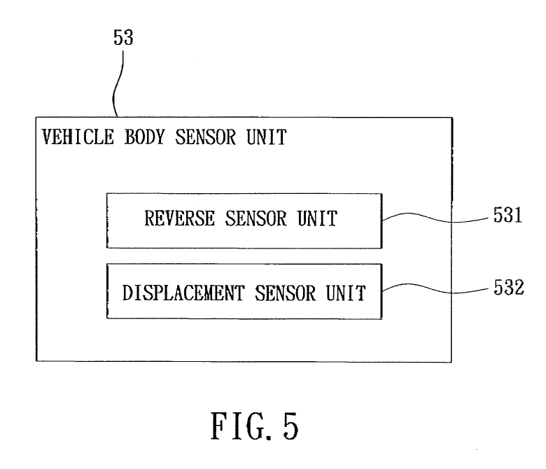

Referring to FIGS. 1, 4, and 5, the central controlling unit 52 is coupled to the ultrasonic positioning module 51, and has a pre-established parking path algorithm 521 and a pre-established minimal parking space 522. The central controlling unit 52 is associated with various controls of the vehicle, and receives the first and second actual coordinate positions of the first and second obstacles and the parking space dimension data from the computation unit 4 of the ultrasonic positioning module 51. When the parking space is not smaller than the minimal parking space 522, the central controlling unit 52 generates a parking path including at least two different steering wheel positions on the basis of the first and second actual coordinates of the first and second obstacles, the parking space dimension data, and the parking path algorithm 521. The central controlling unit 52 subsequently controls the vehicle to park in the parking space along the parking path. Finally, the central controlling unit 52 utilizes a horizontal displacement of the vehicle to determine whether the vehicle is parked in the parking space.

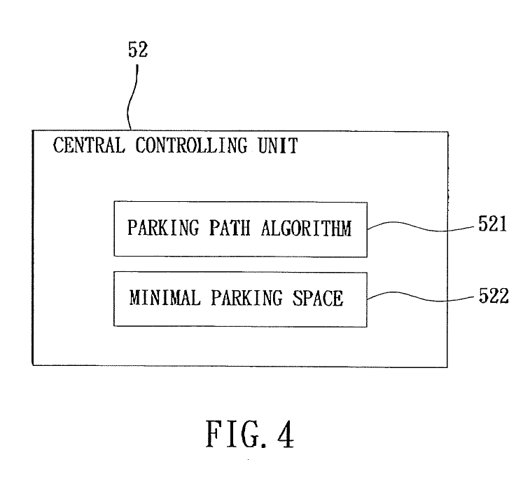

Referring to FIGS. 4 and 6, the parking path algorithm 521 satisfies the conditions,

$$\begin{matrix}H = \sqrt{{L}^{2} + 2 {R}_{min\_out} ( D - {b}_{1} ) - {( D - {b}_{1} )}^{2}} & ( 7 ) \\ {H}_{cr} = H + 2 {b}_{0} & ( 8 ) \\ f = {N}_{s} \times {cot}^{- 1} \{ \frac{\sqrt{{[ \frac{\begin{matrix}{( H + n + {b}_{0} )}^{2} - \\ 2 {R}_{min\_out} ( m + D - {b}_{1} ) - \\ {( m + D - {b}_{1} )}^{2}\end{matrix}}{2 ( m + D - {b}_{1} )} ]}^{2} - {c}^{2} + \frac{W}{2}}}{l} \} & ( 9 ) \\ {S}_{1} = {R}_{s} \times α = {R}_{s} \times {sin}^{- 1} ( \frac{H + n + {b}_{0}}{{R}_{min\_out} + {R}_{s}} ) & ( 10 ) \\ {S}_{2} = {R}_{min\_out} \times α & ( 11 )\end{matrix}$$

where L is a length of the vehicle, Rₘᵢₙ_{_{—}}ₒᵤₜ, is a rotating radius of an inner rear wheel of the vehicle, D is a width of the parking space, b₁ is a horizontal spacing from the vehicle to the curb, H is a length of the parking space, b₀ is a vertical spacing from the vehicle to each of the first obstacle and the second obstacle, H_{cr} is a minimal length of the parking space, n is a vertical spacing between the vehicle at an initial position and the first obstacle, m is a horizontal spacing between the vehicle at the initial position and the first obstacle, c is a distance between a rear wheel axle of the vehicle and a rear end portion of the vehicle, W is a width of the vehicle, l is a distance between a front wheel axle and the rear wheel axle of the vehicle, f is a rotating angle of a steering wheel of the vehicle, N_{S} is a rotating angle ratio between a predetermined rotating angle of the steering wheel and the front wheel of the vehicle, Rₛ is a rotating radius of an outer rear wheel of the vehicle from the initial position to a turning position of the vehicle, α is a turning angle from the initial position to the turning position of the vehicle, S₁ is a moving distance of an arc curve between the initial position and the turning position of the vehicle, S₂ is a moving distance of an arc curve after the turning position to a final position of the vehicle.

Referring to FIGS. 1, 4, and 5, the vehicle sensor unit 53 is coupled to the central controlling unit 52, and detects a vehicle state. The vehicle sensor unit 53 includes a reverse sensor unit 531 for detecting whether the vehicle is being driven in reverse, and a displacement sensor unit 532 for detecting the displacement of the vehicle.

The image capturing unit 54 is used for capturing an image of an area behind the vehicle.

The image display unit 55 is coupled to the central controlling unit 52 and the image capturing unit 54, and compares the parking path and the image of the area behind the vehicle.

The adjusting on-off unit 56 is coupled to the central controlling unit 52 and receives a setting adjustment and correction control from a user. The adjusting on-off unit 56 controls on and off states of the central controlling unit 52. In this embodiment, the image display unit 55 and the adjusting on-off unit 56 are implemented by touchscreen display systems, which can be directly controlled by the user. The pre-established approximate coordinate data 42 includes a pre-set coordinate position of the first obstacle and a pre-set coordinate position of the second obstacle. For example, when the user activates the adjusting on-off unit 56 when at the initial position, since most parallel parking situations are similar in nature, it is possible to have pre-established rough approximations of the positions of the first and second obstacles, that is, the pre-set coordinate positions of the first and second obstacles.

The operators of the automatic parallel parking device 5 of the present invention will now be described.

The vehicle is driven to the initial position, after which the automatic parallel parking device 5 is turned on through the adjusting on-off unit 56. Subsequently, a parking environment map is established by the ultrasonic positioning module 51 and the image capturing unit 54.

Next, the vehicle is automatically braked and the user is instructed to place the vehicle in reverse. The image display unit 55 subsequently displays a predetermined parking space and compares this with an image of an actual parking environment. The adjusting on-off unit 56 is used to verify the parking space. The central controlling unit 52 generates a parking path including at least two different steering wheel positions on the basis of the first and second actual coordinate positions of the first and second obstacles, the parking space dimension data, and the parking path algorithm 521. The number of the steering wheel positions of the parking path is inversely related to the dimensions of the parking space.

As can be known from the above, the turning angle, α, between the initial position and the turning position is determined by the parking path algorithm 521. At this time, for determining the turning position(s), it is necessary only that the resulting distance between the vehicle and each of the first and second obstacles be equal to b₀. That is, during each turn after the first turn, the turning radius is determined by what will be the resulting distances between the vehicle and the front and rear obstacles.

Finally, the central controlling unit 52 controls a steering device, an accelerator, brakes, and other mechanisms of the vehicle to perform automatic parking, during which it is continually detected whether the user is intervening in the operation of the vehicle or whether an additional obstacle appears suddenly. If such detection occurs, the automatic parallel parking device 5 gives control over to the user. The user subsequently uses the adjusting on-off unit 56 to confirm a parking path, and then the automatic parallel parking device 5 starts again so as to finish parking.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An automatic parallel parking device for automatically parking a vehicle in a parking space next to a curb, and between a first obstacle and a second obstacle, the second obstacle being in line with the first vehicle, said automatic parallel parking device comprising:
an ultrasonic positioning module including a plurality of ultrasonic sensor units disposed at different locations of the vehicle, and a computation unit, each of said ultrasonic sensor units detecting a distance to each of the first obstacle and the second obstacle, said computation unit having a pre-established space positioning matrix and pre-established approximate coordinate data, and estimating a first actual coordinate position of the first obstacle and a second actual coordinate position of the second obstacle based on the distances detected by said ultrasonic sensor units, and further based on the space positioning matrix and the approximate coordinate data, said computation unit further estimating parking space dimension data of the parking space based on at least the first and second actual coordinate positions of the first and second obstacles; and
a central controlling unit coupled to said ultrasonic positioning module, said central controlling unit having a pre-established parking path algorithm and a pre-established minimal parking space, said central controlling unit being associated with various controls of the vehicle, and receiving the first and second actual coordinate positions of the first and second obstacles and the parking space dimension data from said computation unit of said ultrasonic positioning module;
wherein when the parking space is not smaller than the minimal parking space, said central controlling unit generates a parking path including at least two different steering wheel positions on the basis of the first and second actual coordinates of the first and second obstacles, the parking space dimension data, and the parking path algorithm, subsequently controls the vehicle to park in the parking space along the parking path, and finally utilizes a horizontal displacement of the vehicle to determine whether the vehicle is parked in the parking space.

2. The automatic parallel parking device as claimed in claim 1, wherein the parking path algorithm satisfies the condition,
H={square root over (L²+2Rₘᵢₙ_{_{—}}ₒᵤₜ(D−b₁)−(D−b₁)²)}
where L is a length of the vehicle, Rₘᵢₙ_{_{—}}ₒᵤₜ, is a rotating radius of an inner rear wheel of the vehicle, D is a width of the parking space, b₁ is a horizontal spacing from the vehicle to the curb, and H is a length of the parking space.

3. The automatic parallel parking device as claimed in claim 2, wherein the parking path algorithm satisfies the condition,
H_{cr}=H+2b₀
where b₀ is a vertical spacing from the vehicle to each of the first obstacle and the second obstacle, and H_{cr} is a minimal length of the parking space.

4. The automatic parallel parking device as claimed in claim 3, wherein the parking path algorithm satisfies the condition,
$$f = {N}_{s} \times {cot}^{- 1} \{ \frac{\sqrt{{[ \frac{\begin{matrix}{( H + n + {b}_{0} )}^{2} - \\ 2 {R}_{min\_out} ( m + D - {b}_{1} ) - \\ {( m + D - {b}_{1} )}^{2}\end{matrix}}{2 ( m + D - {b}_{1} )} ]}^{2} - {c}^{2} + \frac{W}{2}}}{l} \}$$
where n is a vertical spacing between the vehicle at an initial position and the first obstacle, m is a horizontal spacing between the vehicle at the initial position and the first obstacle, c is a distance between a rear wheel axle of the vehicle and a rear end portion of the vehicle, W is a width of the vehicle, l is a distance between a front wheel axle and the rear wheel axle of the vehicle, f is a rotating angle of a steering wheel of the vehicle, and N_{S} is a rotating angle ratio between a predetermined rotating angle of the steering wheel and the front wheel of the vehicle.

5. The automatic parallel parking device as claimed in claim 4, wherein the parking path algorithm satisfies the condition,
$${S}_{1} = {R}_{s} \times α = {R}_{s} \times {sin}^{- 1} ( \frac{H + n + {b}_{0}}{{R}_{min\_out} + {R}_{s}} )$$
where Rₛ is a rotating radius of an outer rear wheel of the vehicle from the initial position to a turning position of the vehicle, α is a turning angle from the initial position to the turning position of the vehicle, and S₁ is a moving distance of an arc curve between the initial position and the turning position of the vehicle.

6. The automatic parallel parking device as claimed in claim 5, wherein the parking path algorithm satisfies the condition,
S₂=Rₘᵢₙ_{_{—}}ₒᵤₜ×α
where S₂ is a moving distance of an arc curve after the turning position to a final position of the vehicle.

7. The automatic parallel parking device as claimed in claim 6, further comprising a vehicle sensor unit coupled to said central controlling unit and detecting a vehicle state, an image capturing unit for capturing an image of an area behind the vehicle, and an image display unit coupled to said central controlling unit and said image capturing unit, said image display unit comparing the parking path and the image of the area behind the vehicle.

8. The automatic parallel parking device as claimed in claim 7, wherein said vehicle sensor unit includes a reverse sensor unit for detecting whether the vehicle is being driven in reverse, and a displacement sensor unit for detecting the displacement of the vehicle.

9. The automatic parallel parking device as claimed in claim 8, further comprising an adjusting on-off unit coupled to said central controlling unit and receiving a setting adjustment and correction control from a user, said adjusting on-off unit controlling on and off states of said central controlling unit.

10. The automatic parallel parking device as claimed in claim 1, wherein the space positioning matrix satisfies the condition,
$$[ \begin{matrix}\frac{( \hat{x} - {x}_{1} )}{{\hat{ρ}}_{1}} & \frac{( \hat{y} - {y}_{1} )}{{\hat{ρ}}_{1}} & \frac{( \hat{z} - {z}_{1} )}{{\hat{ρ}}_{1}} \\ \frac{( \hat{x} - {x}_{2} )}{{\hat{ρ}}_{2}} & \frac{( \hat{y} - {y}_{2} )}{{\hat{ρ}}_{2}} & \frac{( \hat{z} - {z}_{2} )}{{\hat{ρ}}_{2}} \\ ⋮ & ⋮ & ⋮ \\ \frac{( \hat{x} - {x}_{n} )}{{\hat{ρ}}_{n}} & \frac{( \hat{y} - {y}_{n} )}{{\hat{ρ}}_{n}} & \frac{( \hat{z} - {z}_{n} )}{{\hat{ρ}}_{n}}\end{matrix} ]$$
where (\hat{x}, ŷ, \hat{z}) is an estimated coordinate position of one of the first obstacle and the second obstacle, (x₁, y₁, z₁), (x₂, y₂, z₂) and (xₙ, yₙ, zₙ) are coordinate positions respectively of said ultrasonic sensor units, and \hat{ρ}₁, \hat{ρ}₂, . . . , and \hat{ρ}ₙ are the distances detected respectively by the ultrasonic sensor units and said one of the first obstacle and the second obstacle.

11. The automatic parallel parking device as claimed in claim 10, wherein each of the first and second actual coordinate positions is calculated by the conditions,
$$\begin{matrix}[ \begin{matrix}{ρ}_{1} - {\hat{ρ}}_{1} \\ {ρ}_{2} - {\hat{ρ}}_{2} \\ ⋮ \\ {ρ}_{n} - {\hat{ρ}}_{n}\end{matrix} ] = [ \begin{matrix}\frac{( \hat{x} - {x}_{1} )}{{\hat{ρ}}_{1}} & \frac{( \hat{y} - {y}_{1} )}{{\hat{ρ}}_{1}} & \frac{( \hat{z} - {z}_{1} )}{{\hat{ρ}}_{1}} \\ \frac{( \hat{x} - {x}_{2} )}{{\hat{ρ}}_{2}} & \frac{( \hat{y} - {y}_{2} )}{{\hat{ρ}}_{2}} & \frac{( \hat{z} - {z}_{2} )}{{\hat{ρ}}_{2}} \\ ⋮ & ⋮ & ⋮ \\ \frac{( \hat{x} - {x}_{n} )}{{\hat{ρ}}_{n}} & \frac{( \hat{y} - {y}_{n} )}{{\hat{ρ}}_{n}} & \frac{( \hat{z} - {z}_{n} )}{{\hat{ρ}}_{n}}\end{matrix} ] [ \begin{matrix}δ x \\ δ y \\ δ z\end{matrix} ] \\ δ p = {( {H}^{T} H )}^{- 1} {H}^{T} δρ \\ x = \hat{x} + δ x , y = \hat{y} + δ y , z = \hat{z} + δ z\end{matrix}$$
wherein δx, δy, and δz are errors between the estimated coordinate position and the actual coordinate position of said one of the first obstacle and the second obstacle in the x, y, and, z directions, respectively, ρ₁, ρ₂, . . . , and ρₙ are the distances detected respectively by said ultrasonic sensor units, δρ is a matrix formed by a difference between (a) distances between the ultrasonic sensor units and one of the first and second actual coordinate position and (b) distances between the ultrasonic sensor units 3 and the estimated coordinate position of said one of the first obstacle and the second obstacle, H is the space positioning matrix, δp is a matrix formed using δx, δy, and δz, and x, y, and z are components of the actual coordinate position.

12. The automatic parallel parking device as claimed in claim 11, wherein the actual coordinate position of said one of the first obstacle and the second obstacle is calculated by recursive substitution.

13. The automatic parallel parking device as claimed in claim 1, wherein a number of the steering wheel positions of the parking path is inversely related to the dimensions of the parking space.

14. The automatic parallel parking device as claimed in claim 1, wherein said pre-established approximate coordinate data includes a pre-set coordinate position of the first obstacle and a pre-set coordinate position of the second obstacle.
